(19) United States
(12) Patent Application Publication
(10) Pub. No.: US 2025/0199373 A1
(43) Pub. Date: Jun. 19, 2025

(54) HIGH SPEED ELECTRO-OPTIC MODULATOR WITH VARYING ELECTRO-OPTIC MODULATION STRENGTH

(71) Applicant: HyperLight Corporation, Cambridge, MA (US)

(72) Inventors: Sean P. Anderson, Macungie, PA (US); Mian Zhang, Cambridge, MA (US)

(21) Appl. No.: 18/984,619

(22) Filed: Dec. 17, 2024

Related U.S. Application Data
(60) Provisional application No. 63/612,228, filed on Dec. 19, 2023.

(51) Int. Cl. G02F 1/225; G02F 1/21

(52) U.S. Cl. CPC G02F 1/2255; G02F 1/212

(57) ABSTRACT

An electro-optic modulator including a waveguide and electrodes is described. The waveguide has a length proximate to at least a portion of the electrodes. Each electrode of the at least the portion of the electrodes is a traveling wave electrode and has an effective electro-optic modulation strength disposed along a length of the waveguide. The effective electro-optic modulation strength varies along the length of the waveguide.

### CROSS REFERENCE TO OTHER APPLICATIONS

This application claims priority to U.S. Provisional Patent Application No. 63/612,228 entitled HIGH SPEED ELECTRO-OPTIC MODULATOR WITH TAPERING ELECTRODE SPACING filed Dec. 19, 2023 which is incorporated herein by reference for all purposes.

### BACKGROUND OF THE INVENTION

Optical modulators may be used to encode data into optical signals (e.g. visible, infrared, or other portions of the spectrum of light). For example, in an electro-optic modulator, an electrical signal (e.g., having a frequency in the microwave range—from hundreds of kHz through hundreds of GHz) is driven through electrodes that are in proximity to a waveguide. The electric field generated by the electrical signal in the electrodes (also termed “electrode signal”) changes the index of refraction of an electro-optic material that carries the optical signal. The change in index of refraction can provide intensity or phase modulation, depending on the configuration of the waveguide. Thus, data may be encoded and optically transmitted.

High frequency modulation (e.g. 100 MHz through at least 100 GHz or more) is desired to be achieved. In traveling-wave electro-optic modulators, the high-frequency response may be principally limited by the propagation loss of the RF electrodes. In general, the modulation strength of the electrodes (corresponding to the voltage amplitude of the electrode signal required to shift the optical signal by π, or one hundred and eighty degrees) is increased for electrodes separated by a smaller gap, which corresponds to a higher electric field for a given voltage amplitude.

In typical applications, the modulator geometry (including waveguide and electrode dimensions) is held static along the entire length of the modulator. Stated differently, the configurations of the waveguide and the electrodes are each constant in the region where the electrodes are proximate to the waveguide (e.g., where modulation of the optical signal takes place). The specific geometry is chosen by trading off among optical loss, bandwidth, modulation efficiency, impedance, and velocity matching between the electrode signal and the optical signal.

Although such optical modulators function, improvements are desired. In particular, as higher and higher frequency microwave signals are desired to be used for data transmission, the high frequency performance of the optical modulator is desired to be enhanced. Accordingly, what is needed is an optical modulator having improved high frequency performance.

### BRIEF DESCRIPTION OF THE DRAWINGS

Various embodiments of the invention are disclosed in the following detailed description and the accompanying drawings.

FIG. 1 is a diagram depicting an embodiment of an optical modulator having varying effective electro-optic modulation strength.

FIGS. 2A-2B depict an embodiment of an optical modulator having varying effective electro-optic modulation strength.

FIG. 3 depicts an embodiment of an optical modulator having varying effective electro-optic modulation strength.

FIG. 4 depicts an embodiment of an optical modulator having varying effective electro-optic modulation strength.

FIG. 5 depicts an embodiment of an optical modulator having varying effective electro-optic modulation strength.

FIG. 6 depicts an embodiment of an optical modulator having varying effective electro-optic modulation strength.

FIGS. 7A-7B depict an embodiment of an optical modulator having varying effective electro-optic modulation strength.

FIG. 8 depicts an embodiment of an optical modulator having varying effective electro-optic modulation strength.

FIG. 9 is a flow chart depicting an embodiment of a method for using an optical modulator having varying effective electro-optic modulation strength.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Optical modulators may be used to encode data into optical signals (e.g. visible, infrared, or other portions of the spectrum of light). For example, in an electro-optic modulator, an electrical signal (e.g. having a frequency in the microwave range—from approximately one hundred kHz through hundreds of GHz) is driven through electrodes that are in proximity to a waveguide. The signal in the electrodes generates an electric field that modulates the optical signal being driven through the waveguide.

High frequency modulation (e.g. 100 MHz through at least 100 GHz, through at least 200 GHz or more) is desired to be achieved. In traveling-wave electro-optic modulators, the high-frequency response may be limited by the propagation loss of the RF electrodes. In general, the modulation strength of the electrodes corresponds to the voltage amplitude of the electrode signal required to shift the phase of the optical signal by π (V-pi, also known as V-π) multiplied by the length of the waveguide proximate to the electrodes (V-pi*L, where L is the length of the waveguide proximate to the electrodes). In typical applications, the modulator geometry (including waveguide and electrode dimensions as well as the amplitude of the electrode signal) does not vary along the entire length of the modulator. Thus, the effective electro-optic modulation strength may be considered to be constant along the length of the waveguide.

Although such optical modulators function, improvements are desired. In particular, as higher and higher frequency microwave signals are desired to be used for data transmission, the high frequency performance of the optical modulator is desired to be enhanced. Accordingly, what is needed is an optical modulator having improved high frequency performance.

An electro-optic modulator includes a waveguide and electrodes. The waveguide has a length proximate to at least a portion of the electrodes. Each electrode of the at least the portion of the electrodes is a traveling wave electrode and has an effective electro-optic modulation strength disposed along a length of the waveguide. The effective electro-optic modulation strength varies along the length of the waveguide. In some embodiments, the effective electro-optic modulation strength decreases along the length of the waveguide.

In some embodiments, the electrode(s) are separated by a gap that varies along the length of the waveguide such that the effective electro-optic modulation strength varies. In some embodiments, the gap between the electrode(s) monotonically increases along the length of the waveguide. For example, the electrode(s) may have width(s) that vary along the length of the waveguide. In some embodiments, the width(s) of the electrode(s) are tapered such that a first width of an electrode proximate to the input is greater than a second width of the electrode distal from the input. Thus, the gap between the electrodes may increase along the length of the waveguide. The width may be tapered linearly, in steps, in accordance with a nonlinear function, or in another fashion. In at least some embodiments, the width is desired to monotonically decrease.

In some embodiments, an effective gap for electrode signal(s) in the electrode(s) and an optical signal in the waveguide vary along the length of the waveguide such that the effective electro-optic modulation strength varies. In some embodiments, the electrode(s) include extensions extending toward the waveguide. In such embodiments, the extensions are configured such that the effective electro-optic modulation strength varies (e.g., decreases along the length of the waveguide). In some embodiments, the effective electro-optic modulation strength is V-pi*1, where 1 is a distance along the length of the waveguide and V-pi is the voltage for shifting an optical signal by a phase π for a configuration analogous to an electro-optic device configuration at 1, the distance along the length of the waveguide.

In some embodiments, the electrode(s) each have a width that varies along the length of the waveguide such that a gap separating the electrode(s) increases along the length of the waveguide. Thus the effective electro-optic modulation strength decreases along the length of the waveguide.

An electro-optic device including a waveguide and electrodes is described. The waveguide includes multiple arms. An arm of the waveguide is between a portion of the electrodes. The arm has a length proximate to the portion of the electrodes. Each electrode of the portion of the electrodes is a traveling wave electrode and has an effective electro-optic modulation strength disposed along a length of the arm. The effective electro-optic modulation strength varies along the length of the waveguide. In some embodiments, for example, the portion of the electrodes are separated by a gap that varies along the length of the arm such that the effective electro-optic modulation strength varies.

For example, the gap may increase and the effective electro-optic modulation strength may decrease along the length of the arm. In some embodiments, each of the portion of the electrodes has an input and a width that is tapered such that a first width proximate to the input is greater than a second width distal from the input. Thus, the gap increases along the length of the arm. In some embodiments, each electrode of the portion of the electrodes includes extensions extending toward the waveguide arm. The extensions are configured such that the effective electro-optic modulation strength varies. For example, the effective electro-optic modulation strength may be V-pi*1, where 1 is a distance along the length of the waveguide and V-pi is the voltage for shifting an optical signal by a phase π for a configuration analogous to an electro-optic device configuration at 1.

A method for modulating an optical signal is described. An optical signal is provided in a waveguide. An electrode signal is driven through electrodes. The waveguide has a length proximate to at least a portion of the electrodes. Each electrode of the electrode(s) is a traveling wave electrode and has an effective electro-optic modulation strength disposed along a length of the waveguide. The effective electro-optic modulation strength due to the electrode signal varies along the length of the waveguide. In some embodiments, the electrode(s) are separated by a gap that varies along the length of the waveguide such that the effective electro-optic modulation strength varies. In some embodiments, the electrode(s) have width(s) that vary along the length of the waveguide such that the gap monotonically increases along the length of the waveguide.

The techniques may be described in the context of positive and negative electrodes, positive and negative electrical signals (e.g., voltages), positive and negative inputs, and positive and negative outputs. However, such electrodes, voltages, inputs, and outputs carry or are signals that are opposite in polarity with respect to a reference. Stated differently, positive and negative refer to polarity with respect to a reference. In some embodiments, the reference is ground. In some embodiments, the reference is a nonzero voltage. In some embodiments, the reference is constant. In some embodiments, the reference may be slowly varying. In such embodiments, the positive voltage, or signal, has the opposite polarity with respect to the reference as the negative voltage, or signal. Thus, the terms “positive” and “negative” simply indicate that the signals are opposite in polarity with respect to the reference. There is no requirement that the “positive” signal remain positive with respect to the reference or that the “negative” signal remains negative with respect to the reference. Further, although described as ground, in some embodiments, the ground may include a slowly varying voltage. In addition, various features of the electro-optic devices are described herein. One or more of these features may be combined in manners not explicitly described herein. In addition, only portions of the electro-optic devices are shown. For example, in plan views, portions of the waveguide may be separated by a distance out of the plane of the page from portions of the electrode. For example, portions of waveguide may be buried deeper in the device or portions of electrode(s) may be further from substrate structure. Thus, in some embodiments, only the portions of the electrode that are proximate to the waveguide and thus of most interest in modulating optical signals, are shown. Further, although an input is indicated in the drawings, in some embodiments, signals may be reversed such that the input functions as an output.

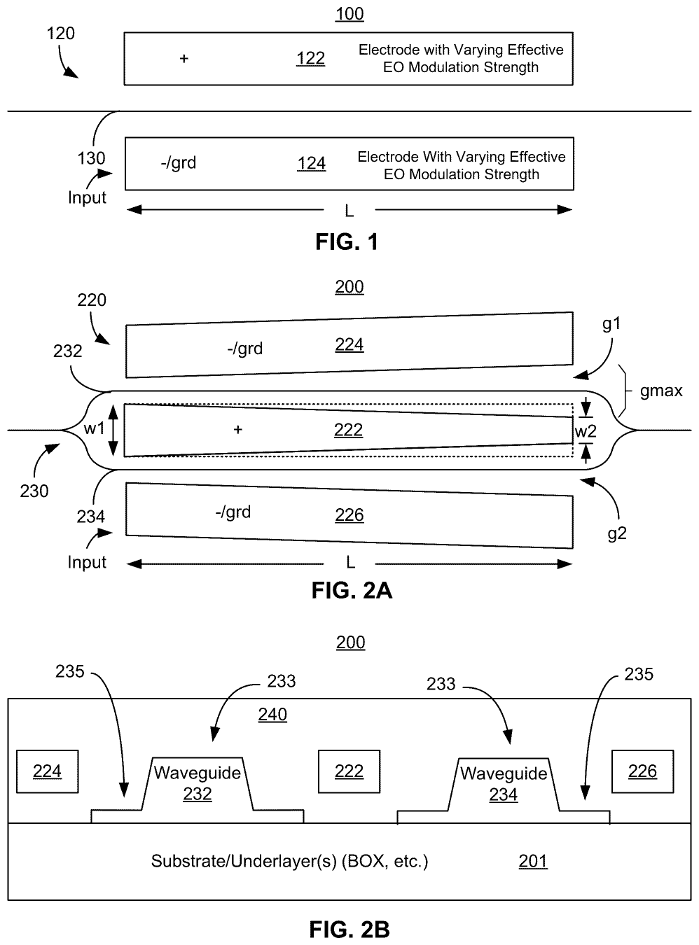

FIG. 1 is a diagram depicting an embodiment of optical modulator 100 having varying effective electro-optic modulation strength. For clarity, FIG. 1 is not to scale and not all components are shown. FIG. 1 may be considered to show portions of optical modulator 100. For example, drivers, voltage sources, the source of the optical signal, and other portions of such a system are not shown. Optical modulator 100 includes electrodes 120 that include positive, or signal electrode 122 and negative or ground electrode 124. Thus, electrodes 120 may be differential electrodes in some embodiments. Although one electrode 122 is indicated as a positive/signal electrode and the other electrode 124 is indicated as a negative/ground electrode, the positions or function of electrodes 122 and 124 may differ. In other embodiments, electrodes 120 need not be differential electrodes. Further, in some embodiments, FIG. 1 may be considered to depict only a portion of an optical modulator, such as an arm of a waveguide having multiple arms (e.g. in a Mach-Zehnder configuration).

Waveguide 130 includes at least one optical material possessing an electro-optic effect. In some embodiments, waveguide 130 includes thin film lithium containing (TFLC) electro-optic materials, such as thin film lithium niobate (TFLN) and/or thin film lithium tantalate (TFLT). In some embodiments, waveguide 130 consists of TFLN and/or TFLT. For example, the thickness of the electro-optic layer(s) form which waveguide 130 are formed is not more than three micrometers prior to fabrication of waveguides 130. In some embodiments, this thickness is not more than 1.5 micrometer or not more than one micrometer. In some embodiments, the thickness is not more than seven hundred nanometers or not more than five hundred nanometers. In some embodiments, the thickness is at least one hundred nanometers. Other thicknesses are possible. The thickness of waveguides 130 is less than or equal to the thickness of the as-provided electro-optic layer. For example, the thickness of waveguides 130 may be on the order of a few hundred nanometers (e.g. 100-300 nanometers) or less.

Although primarily described in the context of (TFLC) electro-optic materials, such as thin film lithium niobate (TFLN) and thin film lithium tantalate (TFLT), other nonlinear optical materials may be used in the optical devices described herein. For example, other ferroelectric nonlinear (e.g. second order) optical materials may also be desired to be used in waveguide 130. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used in waveguide 130 are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguide 130 is a low optical loss waveguide. For example, waveguide 130 may have a total optical loss of not more than 10 dB through the portion of waveguide 130 (e.g. when biased at maximum transmission and as a maximum loss) in proximity to electrodes 120. The total optical loss is the optical loss in a waveguide through a single continuous electrode region (e.g. as opposed to multiple devices cascaded together). In some embodiments, waveguide 130 has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, waveguide 130 has an optical loss of not more than 3 dB/cm (e.g. on average). In some embodiments, the nonlinear material(s) in waveguides 130 has an optical loss of not more than 2.0 dB/cm. In some such embodiments, waveguide 130 has an optical loss of not more than 1.0 dB/cm. In some embodiments, waveguide 130 has an optical loss of not more than 0.5 dB/cm. In some embodiments, the low optical losses are associated with a low surface roughness of the side walls of waveguides 130.

Waveguide 130 may have improved surface roughness. For example, the short range root mean square surface roughness of a sidewall of the ridge may be less than ten nanometers. In some embodiments, this root mean square surface roughness is not more than five nanometers. In some cases, the short range root mean square surface roughness does not exceed two nanometers. In some embodiments, waveguide 130 includes a ridge portion and a slab portion. The height of such a ridge portion is selected to provide a confinement of the optical mode such that there is a 10 dB reduction in intensity from the intensity at the center of the ridge at ten micrometers from the center of the ridge. For example, the height of the ridge is on the order of a few hundred nanometers in some cases. However, other heights are possible in other embodiments. Various other optical components may be incorporated into waveguide 130 to provide the desired functionality. For example, waveguide 130 may have wider portion(s) (not shown in FIG. 1) for accommodating multiple modes or performing other functions.

Optical modulator 100 is usable in high frequency modulation of signals. For example, the optical signals carried by waveguide 130 and/or electrical signals (also termed microwave signals or electrode signals) carried by electrodes 120 are desired to be in a range up to hundred(s) of GHz (e.g. from 100 MHz through at least 100 GHz, from at least 30 GHz, 40 GHz, or 50 GHz through 100 GHz, through at least 200 GHz and/or through at least 200-400 GHz).

Electrodes attenuate high frequencies more than lower frequencies. Radio frequency propagation loss along an electrode thus increases with frequency. Stated differently, the farther from the input of the electrode signal, the higher the losses for the high frequency portion of the signal. Thus, it has been determined that the modulation provided by an entire length of a conventional modulator (e.g. the entire length, L, for which waveguide 130 is proximate to and/or between electrodes 120 if optical modulator 100 were a conventional modulator) may not be useful in high frequency modulation. For example, in some embodiments, only the first few millimeters (e.g. 0-10 millimeters or 0-5 millimeters) may be useful for imparting a high frequency modulation to the optical signal carried by a waveguide. The remaining portion of the length of the conventional modulator may be dominated by lower frequency portions of the electrode signal. Thus, lower frequency modulation would be provided to waveguide by remaining portions of the electrodes.

In contrast to a conventional optical modulator, electrodes 120 and waveguide 130 are configured such that the effective electro-optic modulation strength of optical modulator 100 varies along the length of waveguide 130. In some embodiments, the effective electro-optic modulation strength decreases from the input along the length of waveguide 130. In some embodiments, the electro-optic modulation strength decreases monotonically (i.e. decreases without increasing) along the length of waveguide 130. The effective electro-optic modulation strength may be varied by varying the electric field. For example, the magnitude of the electrode signal may be constant but the gap between electrodes 122 and 124 may increase along the length of waveguide. In such cases, the electric field between electrodes 122 and 124 decreases because of the increasing gap width. In some embodiments, electrodes 120 and/or the electrode signal may be configured to vary along the length of waveguide 130 in addition to or in lieu of the change in the gap. The effective electro-optic modulation strength at a particular point in the waveguide may be given by V-pi*1, where 1 is the distance along the waveguide from the input and V-pi corresponds to the voltage to shift the optical signal by π given the configuration of the waveguide at 1 (e.g. the distance between electrodes 120).

In operation, an optical signal is provided to waveguide 130. Electrode signals (e.g., complementary differential signals or a signal and ground) are provided to electrodes 122 and 124. The electrode signal(s) carried by electrodes 122 and 124 modulate the optical signal in waveguide 130 in regions where electrodes 122 and 124 are proximate to waveguide 130.

Because the effective modulation strength of optical modulation 100 varies along the length of waveguide 130, the amount of modulation provided to waveguide 130 varies. For example, the effective modulation strength may decrease long waveguide 130. As a result, the high frequency modulation provided by the electrode signal(s) operates primarily on the optical signal near the input for waveguide 130 (and for electrodes 120). Thus, the high frequency modulation may take place at the greatest effective modulation strength and prior to attenuation of the high frequency portion of the electrode signal. For example, the effective modulation strength for optical modulator 100 may be highest in the first ten millimeters or the first five millimeters of waveguide 130 between electrodes 122 and 124. Lower frequency modulation that would otherwise be provided to the optical signal closer to the end of waveguide 130 may be reduced because the effective modulation strength of optical modulator 100 may decrease along waveguide 130. Stated differently, optical modulator 100 has improved modulation efficiency for higher frequencies. Thus, in addition to waveguide 130 having low losses and a large electro-optic modulation due to the use of TFLC, optical modulator 100 may have improved performance at higher frequencies (e.g. in the high frequency range described herein).

FIGS. 2A-2B depict an embodiment of optical modulator 200 having varying effective electro-optic modulation strength. FIG. 2A depicts a plan view of optical modulator 200. FIG. 2B depicts a cross-sectional view of optical modulator 200. For clarity, not all components are shown and FIGS. 2A-2B are not to scale. FIG. 2 may be considered to show portions of electro-optic device 200. For example, drivers, voltage sources, the source of the optical signal, and other portions of such a system are not shown.

Optical modulator 200 is analogous to optical modulator 100. Waveguide 230 is analogous to waveguide 130. Thus, waveguide 230 may be a TFLC waveguide having a large electro-optic effect and low optical losses. Waveguide 230 splits to waveguide arms 232 and 234 proximate to electrodes 220 and recombine. Thus, waveguide 230 has a Mach-Zehnder configuration. Waveguide 230, and thus waveguide arms 232 and 234 each include a slab portion 235 and a ridge portion 233. The waveguide mode is well confined to ridge portions 233. Slab portions 235 may assist in directing the electric field from electrodes 220 toward waveguide arms 232 and 234.

Optical modulator 200 includes electrodes 220 that are analogous to electrodes 120. Electrodes 220 include positive, or signal electrode 222 and negative or ground electrodes 224 and 226. Thus, electrodes 220 may be differential electrodes in some embodiments. Although one electrode 222 is indicated as a positive/signal electrode and the other electrodes 224 and 226 are indicated as negative/ground electrodes, the positions or function of electrodes 222, 224, and 226 may differ. In other embodiments, electrodes 220 need not be differential electrodes.

Electrodes 222 and 224 are separated by gap g1. Electrodes 222 and 226 are separated by gap g2. Gaps g1 and g2 vary in size along waveguide arms 232 and 234. In particular, both gaps g1 and g2 increase in size along the length, L, for which waveguide arms 232 and 234 are proximate to electrodes 220. In optical modulator 200, gaps g1 and g2 have the same size and vary in the same manner. In other embodiments, gaps g1 and g2 may differ. In the embodiment shown, electrode 222 tapers linearly from a maximum width w1 at the input to a smallest width w2. Although tapered, electrode 222 may be desired to maintain velocity matching with the optical signal and a similar impedance to an untapered electrode. Electrodes 224 and 226 are angled away from electrode 222. Thus, gaps g1 and g2 increase from the input to a maximum width, gmax, distal from the input. Gaps g1 and g2 linearly increase in width, while electrode 222 linearly tapers. In some embodiments, electrode 222 may have a constant width. In such embodiments, gaps g1 and g2 still increase in size along the length of electrodes 220 because of the configuration of electrodes 224 and 226. Further, gaps g1 and g2 may be smaller proximate to the input than for an optical modulator that is not configured for use at high frequencies. In some embodiments, g1 and g2 may range from at least two micrometers proximate to the input to not more than six micrometers distal from the input. For example, g1 and g2 may range from 3-4 micrometers proximate to the input to 4.5-5.5 micrometers distal from the input. The gaps g1 and g2 described for other optical modulators may have analogous sizes.

In operation, an optical signal is provided to waveguide 230. The optical signal is split and provided to waveguide arms 232 and 234. In some embodiments, optical signals are evenly split between arms 232 and 234 (e.g. half of the intensity to each arm 232 and 234). In other embodiments, the optical signals may be split differently. An electrical signal is provided to electrode 222. In some embodiments, differential signals are provided to electrodes 222 and electrodes 224 and/or 226. The electrode signals carried by electrodes 220 modulate the optical signal in waveguide arms 232 and 234. The modulated optical signal for each arm 232 and 234 of a waveguide 230 may be recombined and then output.

The magnitude of the modulation efficiency is inversely related to the electrode spacing. Because the gaps g1 and g2 increase in size, the effective modulation strength of optical modulation 200 decreases along the length of waveguide arms 232 and 234. Thus, the modulation efficiency is greatest at the beginning of optical modulator 200. Because radio frequency electrodes 220 attenuate high frequencies more strongly than low frequencies, this results in improved modulation efficiency for the highest frequencies. Stated differently, high frequency modulation takes place at the greatest effective modulation strength and prior to attenuation of the high frequency portion of the electrode signal. For example, the effective modulation strength for optical modulator 200 may be highest in the first ten millimeters or the first five millimeters of waveguide arms 232 and 234. Lower frequency modulation that would otherwise be provided to the optical signal closer to the end of waveguide 230 is reduced because the effective modulation strength of optical modulator 200 decreases along waveguide arms 232 and 234. Thus, optical modulator 200 has improved modulation efficiency for higher frequencies. In addition waveguide 230 may have low losses and a large electro-optic modulation due to the use of TFLC. Further, the optical propagation loss of waveguide 230 is inversely related to the electrode spacing. Optical modulator 200 has an electrode spacing that increases along the length L of waveguide 230. Consequently, optical modulator 200 may also be designed to achieve approximately the same total optical loss, while still reaching higher bandwidth. Consequently, high frequency performance of optical modulator 200 is improved.

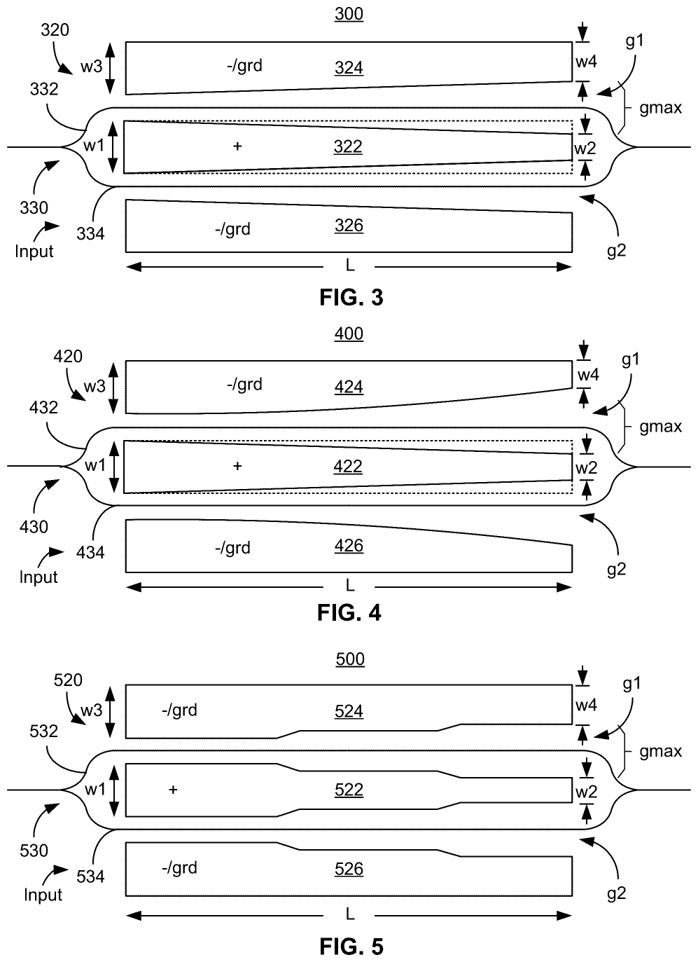

FIG. 3 depicts a plan view of an embodiment of optical modulator 300 having varying effective electro-optic modulation strength. For clarity, not all components are shown and FIG. 3 is not to scale. FIG. 3 may be considered to show portions of electro-optic device 300. For example, drivers, voltage sources, the source of the optical signal, and other portions of such a system are not shown.

Optical modulator 300 is analogous to optical modulators 100 and 200. Waveguide 330 is analogous to waveguide(s) 130 and 230. Thus, waveguide 330 may be a TFLC waveguide having a large electro-optic effect and low optical losses. Waveguide 330 thus includes waveguide arms 332 and 334 analogous to waveguide arms 232 and 234 of waveguide 230. Thus, waveguide 330 has a Mach-Zehnder configuration. Optical modulator 300 also includes electrodes 320 that are analogous to electrodes 120 and 220. Electrodes 320 include electrodes 322, 324, and 326 that are analogous to electrodes 222, 224, and 226.

Electrodes 322 and 324 are separated by gap g1. Electrodes 322 and 326 are separated by gap g2. Gaps g1 and g2 vary in size along waveguide arms 332 and 334. In particular, both gaps g1 and g2 increase in size along the length, L, for which waveguide arms 332 and 334 are proximate to electrodes 320. In optical modulator 300, gaps g1 and g2 are the same size and vary in the same manner. In other embodiments, gaps g1 and g2 may differ. In the embodiment shown, gaps g1 and g2 vary in size because of the configuration of electrodes 320. Electrode 322 tapers linearly from a maximum width w1 at the input to a smallest width w2. Electrodes 324 and 326 taper linearly from width w3 proximate to the input down to a width w4 distal from the input. Although tapered, electrodes 320 may be desired to maintain velocity matching with the optical signal and a similar impedance to untapered electrodes. Thus, gaps g1 and g2 increase from the input to a maximum width, gmax, distal from the input. Gaps g1 and g2 linearly increase in width, while electrodes 322, 324, and 326 linearly taper.

Optical modulator 300 operates in an analogous manner to optical modulator 200 and may share the benefits of optical modulator 200. Because the gaps g1 and g2 increase in size, the effective modulation strength of optical modulation 300 decreases along the length of waveguide arms 332 and 334. Thus, high frequency modulation takes place at the greatest effective modulation strength and prior to attenuation of the high frequency portion of the electrode signal. Lower frequency modulation that would otherwise be provided to the optical signal closer to the end of waveguide 330 is reduced because the effective modulation strength of optical modulator 300 decreases along waveguide arms 332 and 334. Thus, optical modulator 300 has improved modulation efficiency for higher frequencies. In addition, waveguide 330 may have low losses and a large electro-optic modulation due to the use of TFLC. Because optical modulator 300 has an increasing electrode spacing, optical modulator 300 may also be designed to achieve approximately the same total optical loss, while still reaching higher bandwidth. Consequently, high frequency performance of optical modulator 300 is improved.

FIG. 4 depicts a plan view of an embodiment of optical modulator 400 having varying effective electro-optic modulation strength. For clarity, not all components are shown and FIG. 4 is not to scale. FIG. 4 may be considered to show portions of electro-optic device 400. For example, drivers, voltage sources, the source of the optical signal, and other portions of such a system are not shown.

Optical modulator 400 is analogous to optical modulators 100, 200, and 300. Waveguide 430 is analogous to waveguide(s) 130, 230, and 330. Thus, waveguide 430 may be a TFLC waveguide having a large electro-optic effect and low optical losses. Waveguide 430 thus includes waveguide arms 432 and 434 analogous to waveguide arms 232, 332, 234, and 334. Thus, waveguide 430 has a Mach-Zehnder configuration. Optical modulator 400 also includes electrodes 420 that are analogous to electrodes 120, 220, and 320. Electrodes 420 include electrodes 422, 424, and 426 that are analogous to electrodes 222, 224, and 226 and to electrodes 322, 324, and 326. Electrodes 420 are separated by gaps g1 and g2 in an analogous manner to electrodes 220 and 320. Gaps g1 and g2 increase monotonically in size because electrodes 422, 424, and 426 are tapered. Although tapered, electrodes 420 may be desired to maintain velocity matching with the optical signal and a similar impedance to untapered electrodes. However, electrodes 422, 424, and 426 are not tapered linearly. Instead, electrodes 422, 424, and 426 are tapered in accordance with a nonlinear function. Although a particular nonlinear function is shown, other nonlinear functions might be used.

Optical modulator 400 operates in an analogous manner to optical modulators 200 and 300 and may share the benefits of optical modulators 200 and 300. Because the gaps g1 and g2 increase in size, the effective modulation strength of optical modulation 400 decreases along the length of waveguide arms 432 and 434. Thus, high frequency modulation may be enhanced and low frequency modulation reduced. Thus, optical modulator 400 has improved modulation efficiency for higher frequencies. In addition, waveguide 430 may have low losses and a large electro-optic modulation due to the use of TFLC. Because optical modulator 400 has an increasing electrode spacing, optical modulator 400 may also be designed to achieve approximately the same total optical loss, while still reaching higher bandwidth. Consequently, high frequency performance of optical modulator 400 is improved.

FIG. 5 depicts a plan view of an embodiment of optical modulator 500 having varying effective electro-optic modulation strength. For clarity, not all components are shown and FIG. 5 is not to scale. FIG. 5 may be considered to show portions of electro-optic device 500. For example, drivers, voltage sources, the source of the optical signal, and other portions of such a system are not shown.

Optical modulator 500 is analogous to optical modulators 100, 200, 300, and 400. Waveguide 530 is analogous to waveguide(s) 130, 230, 330, and 430. Thus, waveguide 530 may be a TFLC waveguide having a large electro-optic effect and low optical losses. Waveguide 530 thus includes waveguide arms 532 and 534 analogous to waveguide arms 232, 332, 432, 234, 334, and 434. Thus, waveguide 530 has a Mach-Zehnder configuration. Optical modulator 500 also includes electrodes 520 that are analogous to electrodes 120, 220, 320, and 420. Electrodes 520 include electrodes 522, 524, and 526 that are analogous to electrodes 222, 224, and 226, to electrodes 322, 324, and 326, and to electrodes 422, 424, and 426. Electrodes 520 are separated by gaps g1 and g2 in an analogous manner to electrodes 220 and 320. Gaps g1 and g2 increase monotonically in size because electrodes 522, 524, and 526 are tapered. Although tapered, electrodes 520 may be desired to maintain velocity matching with the optical signal and a similar impedance to untapered electrodes. Electrodes 522, 524, and 526 are not tapered linearly. Instead, electrodes 522, 524, and 526 have three zones, each with a distinct (and constant) spacing. Between the zones, the widths of electrodes 522, 524, and 526 undergo smooth transitions. The gap between electrodes 522, 524, and 526 for each zone increases as the distance between the input and the zone increases.

Optical modulator 500 operates in an analogous manner to optical modulators 200, 300, and 400. Optical modulator 500 may thus share the benefits of optical modulators 200, 300, and 400. Because the gaps g1 and g2 increase in size, the effective modulation strength of optical modulation 500 decreases along the length of waveguide arms 532 and 534. Thus, high frequency modulation may be enhanced and low frequency modulation reduced. Thus, optical modulator 500 has improved modulation efficiency for higher frequencies. In addition, waveguide 530 may have low losses and a large electro-optic modulation due to the use of TFLC. Because optical modulator 500 has an increasing electrode spacing, optical modulator 500 may also be designed to achieve approximately the same total optical loss, while still reaching higher bandwidth. Consequently, high frequency performance of optical modulator 500 is improved.

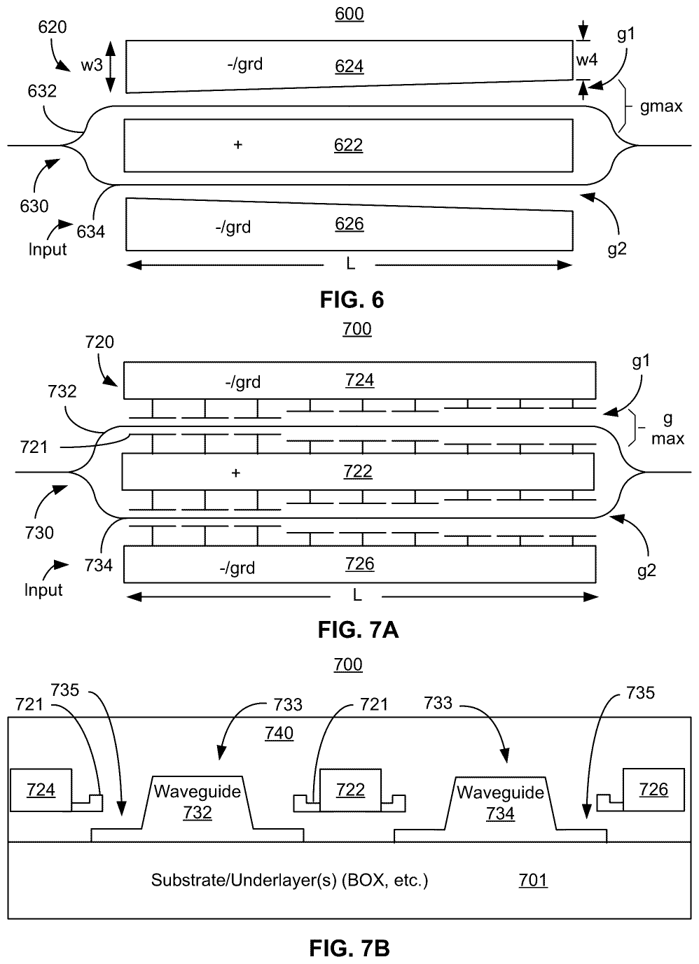

FIG. 6 depicts a plan view of an embodiment of optical modulator 600 having varying effective electro-optic modulation strength. For clarity, not all components are shown and FIG. 6 is not to scale. FIG. 6 may be considered to show portions of electro-optic device 600. For example, drivers, voltage sources, the source of the optical signal, and other portions of such a system are not shown.

Optical modulator 600 is analogous to optical modulators 100, 200, 300, 400, and 500. Waveguide 630 is analogous to waveguide(s) 130, 230, 330, 430, and 530. Thus, waveguide 630 may be a TFLC waveguide having a large electro-optic effect and low optical losses. Waveguide 630 thus includes waveguide arms 632 and 634 analogous to waveguide arms 232, 332, 432, 532, 234, 334, 434, and 534. Thus, waveguide 630 has a Mach-Zehnder configuration. Optical modulator 600 also includes electrodes 620 that are analogous to electrodes 120, 220, 320, and 420. Electrodes 620 include electrodes 622, 624, and 626 that are analogous to electrodes 222, 224, and 226, to electrodes 322, 324, and 326, to electrodes 422, 424, and 426, and to electrodes 522, 524, and 526. Electrodes 620 are separated by gaps g1 and g2 in an analogous manner to electrodes 220, 320, 420, and 520. Gaps g1 and g2 increase monotonically in size because electrodes 624 and 626 are tapered. However, electrode 622 has a constant width. Because only electrodes 624 and 626 are tapered, the ohmic drop in center electrode 622 may be reduced. Consequently, performance of electrodes 620 may be improved.

Optical modulator 600 operates in an analogous manner to optical modulators 200, 300, 400, and 500. Optical modulator 600 may share the benefits of optical modulators 200, 300, 400, and 500. Because the gaps g1 and g2 increase in size, the effective modulation strength of optical modulation 600 decreases along the length of waveguide arms 632 and 634. Thus, high frequency modulation may be enhanced and low frequency modulation reduced. Thus, optical modulator 600 has improved modulation efficiency for higher frequencies. In addition, waveguide 630 may have low losses and a large electro-optic modulation due to the use of TFLC. Because optical modulator 600 has an increasing electrode spacing, optical modulator 600 may also be designed to achieve approximately the same total optical loss, while still reaching higher bandwidth. Consequently, high frequency performance of optical modulator 600 is improved.

FIGS. 7A-7B depict plan and cross-sectional views an embodiment of optical modulator 700 having varying effective electro-optic modulation strength. For clarity, not all components are shown and FIGS. 7A-7B are not to scale. FIGS. 7A-7B may be considered to show portions of electro-optic device 700. For example, drivers, voltage sources, the source of the optical signal, and other portions of such a system are not shown.

Optical modulator 700 is analogous to optical modulators 100, 200, 300, 400, 500, and 600. Waveguide 730 is analogous to waveguide(s) 130, 230, 330, 430, 530, and 630. Thus, waveguide 730 may be a TFLC waveguide having a large electro-optic effect and low optical losses. Waveguide 730 thus includes waveguide arms 732 and 734 analogous to waveguide arms 232, 332, 432, 532, 632, 234, 334, 434, 534, and 634. Each waveguide arm 732 and 734 includes ridge portion 733 and slab portion 735. In some embodiments, slab portion 735 may be omitted from arm 732 and/or 734. The optical modes carried by waveguide arms 732 and 734 are generally well confined to ridge portion 733. Thus, waveguide 730 has a Mach-Zehnder configuration.

Optical modulator 700 also includes electrodes 720 that are analogous to electrodes 120, 220, 320, 420, 520, and 620. Electrodes 720 include electrodes 722, 724, and 726 to the corresponding ones of electrodes 120, 220, 320, 420, 520, and 620. Thus, electrodes 720 include positive/signal electrode 722, and negative/ground electrodes 724 and 726. In some embodiments, extensions 721 may extend from electrodes 720. Although all electrodes 720 are shown as having extensions, in some embodiments, one or more electrode may not include extensions. Although shown as having a T-shape in FIG. 7A, extensions 721 may have another shape. Extensions 721 may allow for accumulation of charges closer to arms 732 and 734 (e.g., ridges 733) of waveguide 730. These charges are due to the electrode signals carried by electrodes 720. Thus, extensions 721 may enhance the electric field experienced by ridge 733 and improve modulation of the optical signal carried by arms 732 and 734. Embodiments of analogous electrodes may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes.

Electrodes 720 are separated by gaps g1 and g2 in an analogous manner to electrodes 220, 320, 420, 520, and 620. Gaps g1 and g2 are between extensions 721 for electrodes 722, 724, and 726. Gaps g1 and g2 also increase monotonically. More specifically, extensions 731 are configured to terminate at a varying distance from the main, channel portion of electrodes 722, 724, and 726. Thus, gap g1 is between extensions 721 for electrode 722 and extensions 721 for electrode 724. Similarly, gap g2 is between extensions 721 for electrode 722 and extensions 721 for electrode 726. Although the distance between the end of extensions 721 and the main, channel portions of electrodes 722, 724, and 726 vary, in some embodiments, the lengths of extensions 721 along the direction of travel of the electrode signal may be constant. This allows the packing (number of extensions per unit length) for electrodes 720 to remain constant. In other embodiments, these lengths may vary also.

Optical modulator 700 operates in an analogous manner to optical modulators 200, 300, 400, 500, and 600. Optical modulator 700 may share the benefits of optical modulators 200, 300, 400, 500, and 600. Because the gaps g1 and g2 increase in size, the effective modulation strength of optical modulation 700 decreases along the length of waveguide arms 732 and 734. Thus, high frequency modulation may be enhanced and low frequency modulation reduced. Thus, optical modulator 700 has improved modulation efficiency for higher frequencies. In addition, waveguide 730 may have low losses and a large electro-optic modulation due to the use of TFLC. Because optical modulator 700 has an increasing electrode spacing, optical modulator 700 may also be designed to achieve approximately the same total optical loss, while still reaching higher bandwidth. The use of extensions 721 may allow for an increase in the modulation. Consequently, high frequency performance of optical modulator 700 is improved.

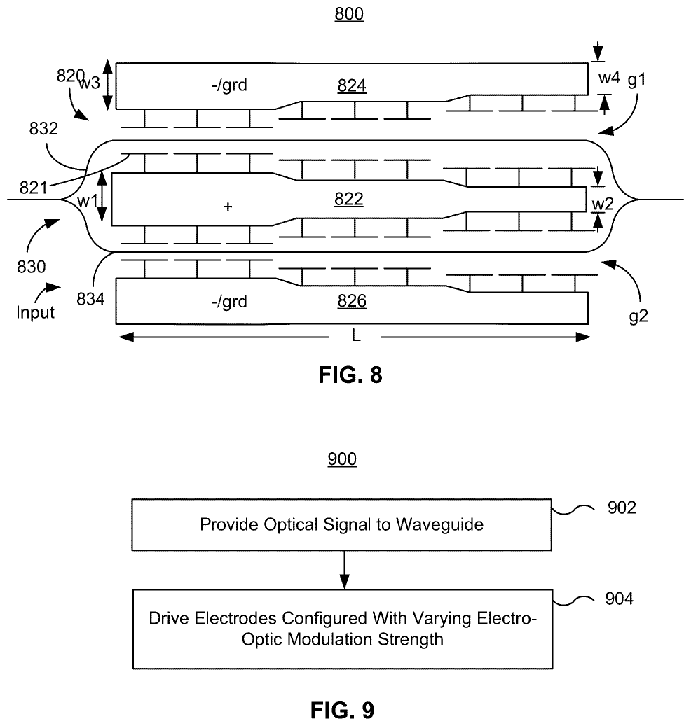

FIG. 8 depicts an embodiment of optical modulator 800 having varying effective electro-optic modulation strength. For clarity, not all components are shown and FIG. 8 is not to scale. FIG. 8 may be considered to show portions of electro-optic device 800. For example, drivers, voltage sources, the source of the optical signal, and other portions of such a system are not shown.

Optical modulator 800 is analogous to optical modulators 100, 200, 300, 400, 500, 600, and 700. Waveguide 830 is analogous to waveguide(s) 130, 230, 330, 430, 530, 630, and 730. Thus, waveguide 830 may be a TFLC waveguide having a large electro-optic effect and low optical losses. Waveguide 830 thus includes waveguide arms 832 and 834 analogous to waveguide arms 232, 332, 432, 532, 632, 732, 234, 334, 434, 534, 634, and 734. Thus, waveguide 830 has a Mach-Zehnder configuration.

Optical modulator 800 also includes electrodes 820 that are analogous to electrodes 120, 220, 320, 420, 520, 620, and 720. Electrodes 820 include electrodes 822, 824, and 826 to the corresponding ones of electrodes 120, 220, 320, 420, 520, 620, and 720. Thus, electrodes 820 include positive/signal electrode 822, and negative/ground electrodes 824 and 826. In some embodiments, extensions 821 may extend from electrodes 820. Although all electrodes 820 are shown as having extensions 821, in some embodiments, one or more electrodes may not include extensions. Extensions 821 are analogous to extensions 721.

Electrodes 820 are separated by gaps g1 and g2 in an analogous manner to electrodes 220, 320, 420, 520, 620, and 720. Gaps g1 and g2 are between extensions 821 for electrodes 822, 824, and 825. Gaps g1 and g2 also increase monotonically. More specifically, the main, channel portions of electrodes 822, 824, and 826 are tapered. Although tapered, electrodes 820 may be desired to maintain velocity matching with the optical signal and a similar impedance to untapered electrodes. Extensions 831 are configured to terminate at the same distance from the main, channel portion of electrodes 822, 824, and 826. Thus, gap g1 is between extensions 821 for electrode 822 and extensions 821 for electrode 824. Similarly, gap g2 is between extensions 821 for electrode 822 and extensions 821 for electrode 826. In some embodiments, the lengths of extensions 821 along the direction of travel of the electrode signal may be constant. This allows the packing (number of extensions per unit length) for electrodes 820 to remain constant. In other embodiments, these lengths may vary also.

Optical modulator 800 operates in an analogous manner to optical modulators 200, 300, 400, 500, 600, and 700. Optical modulator 800 may share the benefits of optical modulators 200, 300, 400, 500, 600, and 700. Because the gaps g1 and g2 increase in size, the effective modulation strength of optical modulation 800 decreases along the length of waveguide arms 832 and 834. Thus, high frequency modulation may be enhanced and low frequency modulation reduced. Thus, optical modulator 800 has improved modulation efficiency for higher frequencies. In addition, waveguide 830 may have low losses and a large electro-optic modulation due to the use of TFLC. Because optical modulator 800 has an increasing electrode spacing, optical modulator 800 may also be designed to achieve approximately the same total optical loss, while still reaching higher bandwidth. The use of extensions 821 may allow for an increase in the modulation. Consequently, high frequency performance of optical modulator 800 is improved.

FIG. 9 is a flow chart depicting an embodiment of method 900 for using an optical modulator for high frequency modulation. Thus, method 900 may be used to modulate optical signal(s). Method 900 is described in the context of processes that may have sub-processes. Although described in a particular order, another order not inconsistent with the description herein may be utilized. Further, although described in the context of a single optical signal, method 900 may be extended to multiple optical signals and multiple differential signals.

An optical signal is provided to a waveguide, at 902. In some embodiments, the waveguide splits into arms of a waveguide (e.g. the arms of a Mach-Zehnder interferometer). Thus, 902 and 904 may include providing a single optical signal to a waveguide including splitter(s). The waveguide carries the signal and, because of the presence of the splitter(s), divides the signal between at least two arms of the waveguide.

Electrode signals are driven through electrodes that correspond to the first and second waveguides, at 904. The effective electro-optic modulation strength due to the electrode signal varies along the length of the waveguide. In some embodiments, the electrode(s) are separated by a gap that varies along the length of the waveguide such that the effective electro-optic modulation strength varies. In some embodiments, the electrode(s) have width(s) that vary along the length of the waveguide such that the gap monotonically increases along the length of the waveguide. Thus, the electrode signal provided at 904 may have a varying (e.g., decreasing) effective electro-optic modulation strength.

For example, method 900 may be used with electro-optic device 200. At 902, an optical signal is provided to waveguide 230. The optical signal is desired to be modulated. At 904, electrode signal(s) are provided to electrode 220. For example, differential signals may be provided to electrode 222 and 224/226 or a signal may be provided to electrode 222 and electrode 224 and 226 may be ground. Because gaps g1 and g2 increase in size along the length L of waveguide arms 232 and 234, the effective electro-optic modulation strength provided by the electrode signal driven at 904 varies.

Using method 900, the benefits of optical modulators 200, 300, 400, 500, 600, 700, and/or 800 may be achieved. Improved modulation efficiency for higher frequencies may be realized. Consequently, high frequency performance of optical modulators, such as optical modulators 100, 200, 300, 400, 500, 600, 700, and/or 800 is improved.

Although the foregoing embodiments have been described in some detail for purposes of clarity of understanding, the invention is not limited to the details provided. There are many alternative ways of implementing the invention. The disclosed embodiments are illustrative and not restrictive.

1. An electro-optic modulator, comprising:
a waveguide; and
a plurality of electrodes, the waveguide having a length proximate to at least a portion of the plurality of electrodes, each electrode of the at least the portion of the plurality of electrodes being a traveling wave electrode and having an effective electro-optic modulation strength disposed along a length of the waveguide;
wherein the effective electro-optic modulation strength varies along the length of the waveguide.

2. The electro-optic modulator of claim 1, wherein the at least a portion of the plurality of electrodes are separated by a gap that varies along the length of the waveguide such that the effective electro-optic modulation strength varies.

3. The electro-optic modulator of claim 2, wherein the each of the at least the portion of the plurality of electrodes has a width that varies along the length of the waveguide.

4. The electro-optic modulator of claim 3 wherein each of the at least the portion of plurality of electrodes has an input and the width is tapered such that a first width proximate to the input is greater than a second width distal from the input.

5. The electro-optic modulator of claim 4, wherein the width is tapered linearly, in steps, or in accordance with a nonlinear function.

6. The electro-optic modulator of claim 2, wherein the gap monotonically increases along the length of the waveguide.

7. The electro-optic modulator of claim 1, wherein an effective gap for at least one electrode signal in the at least a portion of the plurality of electrodes and an optical signal in the waveguide vary along the length of the waveguide such that the effective electro-optic modulation strength varies.

8. The electro-optic modulator of claim 1, wherein the at least the portion of the plurality of electrodes includes a plurality of extensions extending toward the waveguide and wherein the plurality of extensions is configured such that the effective electro-optic modulation strength varies.

9. The electro-optic modulator of claim 1, wherein the effective electro-optic modulation strength is V-pi*1, where 1 is a distance along the length of the waveguide and V-pi is the voltage for shifting an optical signal by a phase π for a configuration analogous to an electro-optic device is configuration at 1, the distance along the length of the waveguide.

10. The electro-optic modulator of claim 1, wherein the each of the at least the portion of the plurality of electrodes has a width that varies along the length of the waveguide such that a gap separating the at least the portion of the plurality of electrodes increases along the length of the waveguide such that the effective electro-optic modulation strength decreases along the length of the waveguide.

11. An electro-optic device, comprising:
a waveguide having a plurality of arms; and
a plurality of electrodes, an arm of the plurality of arms being between a portion of the plurality of electrodes, the arm having a length proximate to the portion of the plurality of electrodes, each electrode of the portion of the plurality of electrodes being a traveling wave electrode and having an effective electro-optic modulation strength disposed along a length of the arm;
wherein the effective electro-optic modulation strength varies along the length of the waveguide.

12. The electro-optic device of claim 11, wherein the portion of the plurality of electrodes are separated by a gap that varies along the length of the arm such that the effective electro-optic modulation strength varies.

13. The electro-optic device of claim 12, wherein each of the portion of the plurality of electrodes has an input and a width that is tapered such that a first width proximate to the input is greater than a second width distal from the input.

14. The electro-optic device of claim 13, wherein the gap increases along the length of the arm.

15. The electro-optic device of claim 12, wherein each of the portion of the plurality of electrodes includes a plurality of extensions extending toward the waveguide and wherein the plurality of extensions is configured such that the effective electro-optic modulation strength varies.

16. The electro-optic device of claim 12, wherein the effective electro-optic modulation strength is V-pi*1, where 1 is a distance along the length of the waveguide and V-pi is the voltage for shifting an optical signal by a phase π for a configuration analogous to an electro-optic device configuration at 1, the distance along the length of the waveguide.

17. The electro-optic device of claim 11, wherein each of the portion of the plurality of electrodes has a width that varies along the length of the waveguide such that a gap separating the portion of the plurality of electrodes increases along the length of the arm such that the effective electro-optic modulation strength decreases along the length of the arm.

18. A method for modulating an optical signal, comprising:
providing an optical signal in a waveguide; and
driving an electrode signal through a plurality of electrodes, the waveguide having a length proximate to at least a portion of the plurality of electrodes, each electrode of the at least the portion of the plurality of electrodes being a traveling wave electrode and having an effective electro-optic modulation strength disposed along a length of the waveguide;
wherein the effective electro-optic modulation strength due to the electrode signal varies along the length of the waveguide.

19. The method of claim 18, wherein the at least a portion of the plurality of electrodes are separated by a gap that varies along the length of the waveguide such that the effective electro-optic modulation strength varies.

20. The method of claim 19, wherein the each of the at least the portion of the plurality of is electrodes has a width that varies along the length of the waveguide such that the gap monotonically increases along the length of the waveguide.
